(19) United States
(12) Patent Application Publication
(10) Pub. No.: US 2008/0300978 A1
(43) Pub. Date: Dec. 4, 2008

(54) DISPLAY SYSTEM INCLUDING MINIATURE SIZE ARTICLE AND ACCESSORIES

(76) Inventor: Richard Roman, New York, NY (US)

Correspondence Address: STITES & HARBISON PLLC, 1199 NORTH FAIRFAX STREET, SUITE 900, ALEXANDRIA, VA, 22314, US

(21) Appl. No.: 11/757,603

(22) Filed: Jun. 4, 2007

(51) Int. Cl. G06Q 50/00; G06Q 90/00

(52) U.S. Cl. 705/14; 434/72

(57) ABSTRACT

A system and method for displaying full size items for sale includes a shelving unit having a top and one or more shelves beneath the top on which items are displayed for sale. A miniature size article is displayed on the top, where the miniature size article includes a plurality of miniature size items associated with the miniature size article. Then, a plurality of full size items, corresponding to the miniature size items, are displayed on the shelves. A transparent cover can be disposed over the miniature size article. The miniature size scale article can be an article of furniture, such as a bed and such that the full scale items include bed accessories. Further, additional full size items, which are designed to coordinate with one or more of the plurality of full size items, and are also displayed on the shelves.

### BACKGROUND OF THE INVENTION

When a small item is stacked for sale in a store, a sample thereof is frequently also displayed for sale adjacent or nearby to the stack of items. For larger items, a display of the item may be provided instead by the packaging thereof, such as by a picture of the item on the package or by making the item transparent. However, it is sometimes difficult for the consumer to envision how a plurality of large items designed to be used together might go together.

### BRIEF SUMMARY OF THE INVENTION

In accordance with the present invention, a system and method are provided for displaying full size items for sale, where the system and method show how the full size items coordinate by displaying adjacent to the full size items corresponding miniature size items located on a miniature article. The present invention thus includes a shelving unit having a top and one or more shelves beneath the top on which full size items used with an article are displayed for sale. A miniature size article is displayed on the top, where the miniature size article includes a plurality of miniature size items associated with the miniature size article. Then, a plurality of full size items, corresponding to the miniature size items on the miniature article, are displayed on the shelves for sale. More than one miniature size article can be placed on top of the unit and in such case full size items corresponding to the miniature size items on all of the miniature size articles on the top of the unit are displayed on the shelves for sale.

Optionally, a transparent cover is disposed over the miniature size article and associated miniature size items. Advantageously, the miniature size article is an article of furniture, such as a bed and such that the full scale items include bed accessories. Further, additional full size items, which are designed to coordinate with one or more of the plurality of full size items, are also displayed on the shelves.

In a preferred embodiment, the shelving unit is rectangular, and it includes compartments on three sides in which shelves are disposed. In addition, a scale of the miniature size items to the full size items is smaller than about 1:4.

It is an object of the present invention to provide a miniature size display of an article so that a buyer can view a miniature size article such as a bed, together with miniature size items associated with the article such as bed accessories, to determine if the full size items are attractive and coordinate, and hence if the full size items should be purchased by the buyer.

It is also an object of the present invention to display additional full size items which coordinate with the plurality of full size items to offer the buyer additional coordinated choices of full size items.

Other features and advantages of the present invention are stated in or apparent from detailed descriptions of presently preferred embodiments of the invention found hereinbelow.

### BRIEF DESCRIPTION OF THE SEVERAL VIEWS OF THE DRAWINGS

FIG. 1 is a front perspective view of a display system according to the present invention.

FIG. 2 is a perspective left side and back view of the display system depicted in FIG. 1.

FIG. 3 is a front perspective view of a top portion of a display system with two miniature articles displayed.

### DETAILED DESCRIPTION OF THE INVENTION

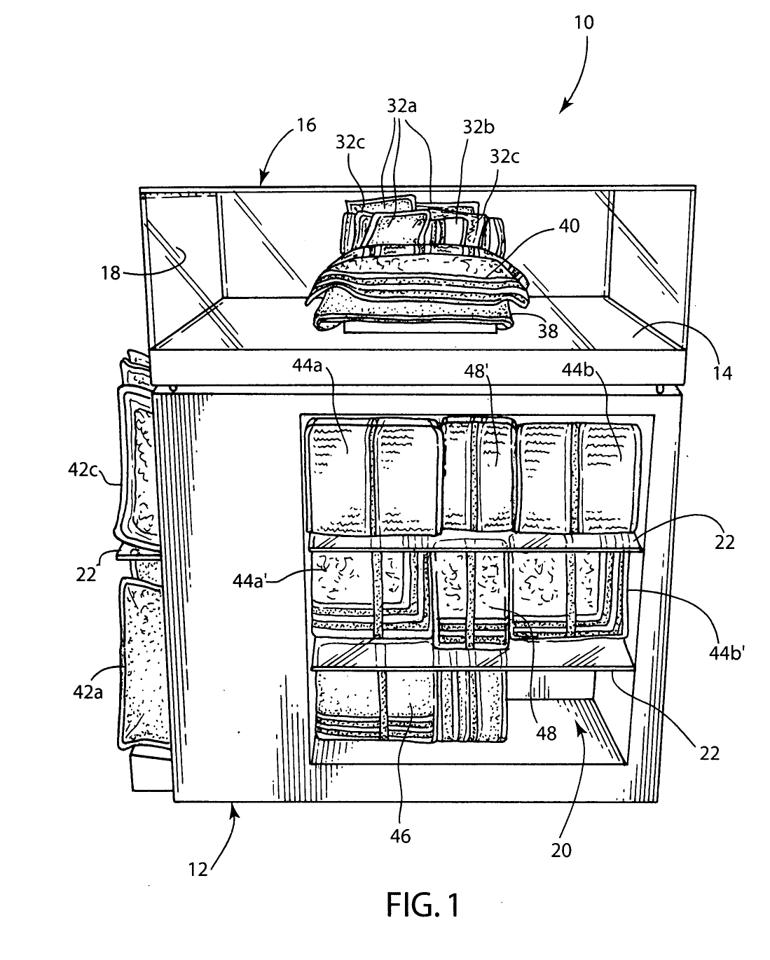

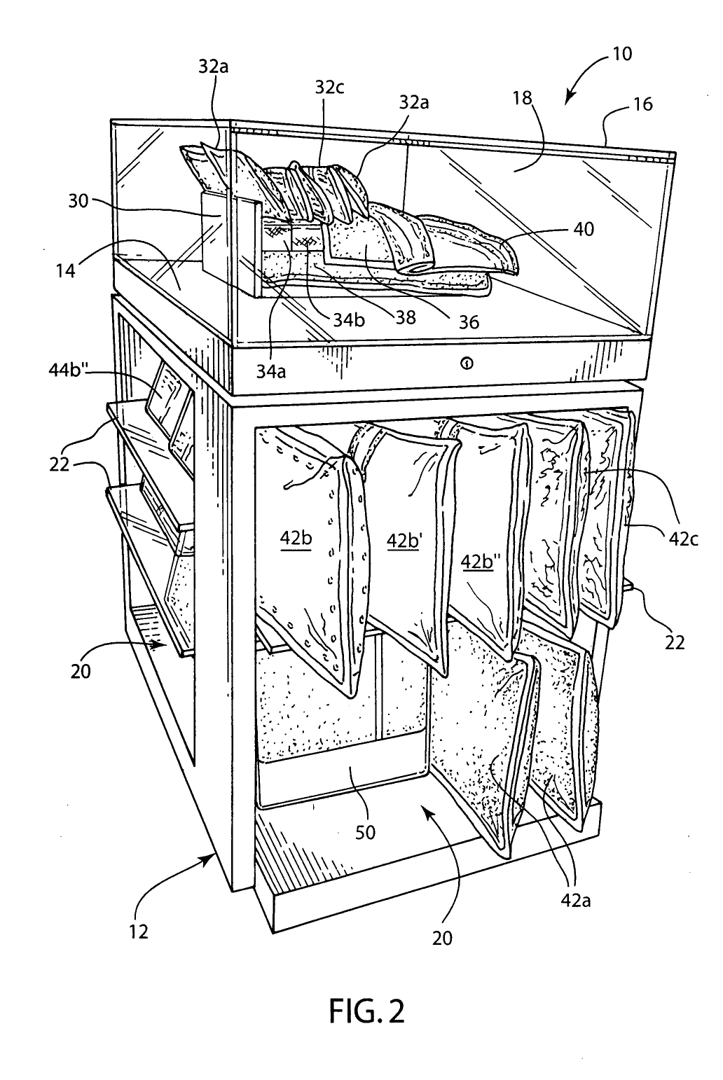

With reference now to the drawings in which like numerals represent like elements throughout the two views, a display system 10 in accordance with an embodiment of the present invention is shown in FIGS. 1 and 2. Display system 10 includes a shelving unit 12, which in this embodiment is rectangular with a rectangular top 14. A transparent cover 16 seats on top 14 and is preferably secured thereto, and for convenience cover 16 has a hinged side panel 18. Side panel 18 can be locked in place using a lock 19 known in the art. Alternatively, transparent cover can also be a lift-off type cover which is not otherwise held in place. Shelving unit 12 also includes a plurality of compartments 20, which in this depicted embodiment are provided in three of the side walls thereof and in which adjustable shelves 22 or the like are additionally provided as desired. Of course, compartments or just the shelves can be provided on all four walls, or just one or two walls as desired.

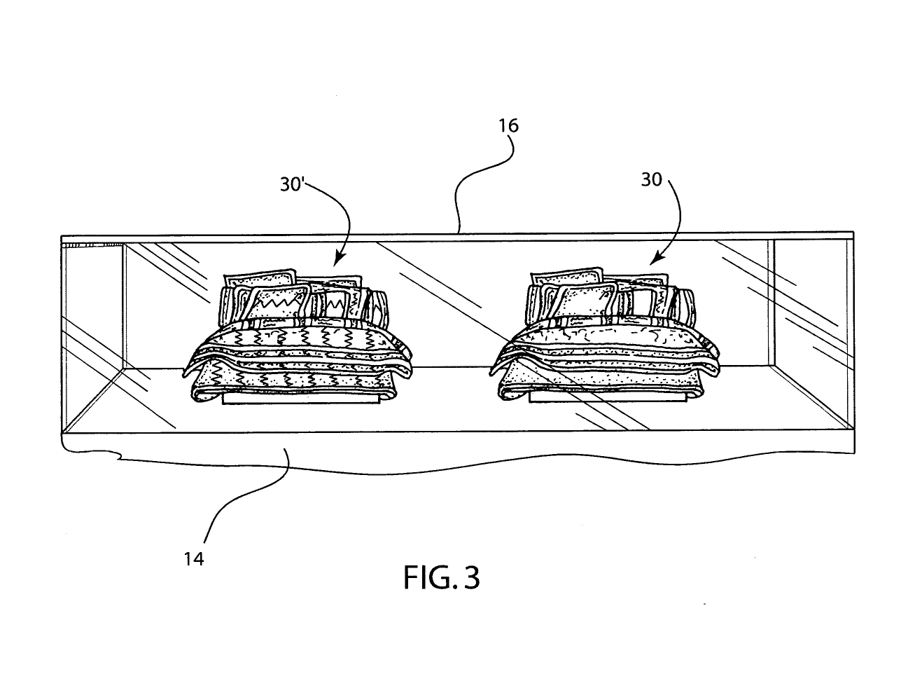

Provided beneath top panel 18 on top 14 for viewing by a consumer adjacent display system 10 is a miniature size article (or articles if desired, see FIG. 3), which in this embodiment is a miniature size bed 30. Miniature size bed 30 is sized on a scale to be less than about 1:4 in each linear dimension of a regular bed, or at least to be fitted beneath transparent cover 16. Displayed on miniature size bed 30 is a plurality of miniature size items associated with miniature size bed 30. In particular, the miniature size items for miniature size bed 30 are bed accessories, such as the following exemplarily accessories (where the suffixed letter a, b, etc. represents a different style, material, and/or pattern of the item): miniature size decorative pillows 32a, 32b and 32c; a miniature size flat sheet 34a and a same (or different) pattern miniature size fitted sheet 34b; a miniature size coverlet 36; a miniature size bed skirt 38; and a miniature duvet or comforter 40. It will be appreciated that the miniature size bed accessories are provided in a similar scale to miniature size bed 30, though the patterns thereof may be exaggerated (shown larger than the miniature scale) to better allow the consumer to appreciate the corresponding full size pattern of the full size item. It will also be appreciated that the miniature size items are typically designed to coordinate with each other, such as by color, pattern, or color and pattern, complementary colors, etc.

In association with miniature size items 32, 34, 36, 38 and 40, full size items 42, 44 and 46 corresponding in appearance to miniature size items 32, 34, 36, 38 and 40 are then provided in compartments 20 and/or on shelves 22 of display system 10. Thus, the same patterns and/or style of miniature size decorative pillows 32a-c, miniature size sheets 34a-b; miniature size coverlet 36; miniature size bed skirt 38; miniature size duvet/comforter 40 are provided in full size in various compartments 20 respectively as shown by: full size decorative pillows 42a, 42b and 42c; full size fitted and flat sheets 44a, 44b, full size coverlet 46; full size bed skirt 48; and full size duvet/comforter 50.

It will be noted that in addition to full size decorative pillow 42b (corresponding to miniature size decorative pillow 32b), this same style of decorative pillow is also provided in different coordinated colors by decorative pillow 42b′ and decorative pillow 42b″ (as by colors brown, black and tan). In a similar manner; for each decorative pillow, other decorative pillows in leather, fabric or fuzzy/plush decorative pillows in different colors and/or patterns, including the same color/patterns as the sheets or other accessories could be provided. Thus, other full size items coordinated with those shown in miniature size can also be and preferably are provided as desired by the merchant.

Another example of additional full size items which could be provided for each style/pattern/color of fitted and flat sheets, coverlet, bed skirt or duvet/comforters, are full sizes of all these coverings in each style/pattern/color as well as for different bed sizes (single, double, queen and king) as the merchant desires or needs. Thus, exemplarily shown are flat sheet 44b″ is a single size sheet with the same pattern as queen size flat sheet 44b. Further exemplarily shown are: fitted and flat sheets 44a and 44b and bed skirt 48′ which have the same pattern; and similarly fitted and flat sheets 44a′ and 44b′ which have the same pattern as bed skirt 48. Of course, the matching sheets 44 and bed skirts 48 (and other items) purchased by a user typically do not all match but rather simply all coordinate as desired by the user, so that each user is free to pick whatever combinations of matching and coordinating accessories are desired—and are made available at the merchant's choice. Further, bedspreads, blankets, pillowcases, etc. could additionally be provided which match or coordinate with any of the provided items.

With shelving system 10, a consumer can view miniature size bed 30 underneath transparent cover 16 in association with miniature size decorative pillows 32, miniature size sheets 34, miniature coverlets 36, miniature size bed skirts 38, and miniature duvets/comforters 40. Of course, where there is sufficient room for both the miniature size articles and the associated full size items, it would be preferred to have a plurality of miniature size beds or the like can be located together underneath the cover. Thus, as depicted in FIG. 3, there are displayed miniature bed 30 (as described above) together with another miniature bed 30′ having miniature size coordinating accessories which are different (or mostly different) from those of miniature bed 30. If the consumer likes one or more of the miniature size items (see miniature size items 32, 34, 36, 38 and/or 40 as described above), or more likely an ensemble or pattern set of such miniature size items from both beds 30 and 30′, the consumer can then find the full size items (see full size items 42, 44, 46, 48 and 50 as described above) underneath top 14 in compartments 20 either on the bottom thereof or on shelves 22. The consumer gets to see how the various miniature size items go together (coordinate) on the beds, and thus to determine which full size articles will likewise go together (coordinate) on a full size bed and retrieve such full size items 42, 44 and 46 for purchase from compartments 20. In addition, by providing additional full size items in the same or different colors/patterns, the consumer is offered additional choices while still being able to visualize the coordination of the full size items with the help of miniature size beds 30 and 30′ and the accompanying miniature sized items provided thereon.

While the present invention has been described with respect to an exemplary embodiment thereof, it will be understood by those of ordinary skill in the art that variations and modifications can be effected within the scope and spirit of the invention.

I claim:

1. A display system comprising:
a miniature size article displayed on top of a shelving unit having one or more shelves beneath the top, the miniature size article including a plurality of miniature size items associated with said miniature size article; and
a plurality of full size items, corresponding to said miniature size items, which are displayed on said shelves.

2. A display system as claimed in claim 1, and further including a transparent cover disposed over said miniature size article.

3. A display system as claimed in claim 1, where said miniature size scale article is an article of furniture.

4. A display system as claimed in claim 3, wherein said miniature size article of furniture is a bed, and wherein said full scale items include bed accessories.

5. A display system as claimed in claim 1, wherein said shelving unit is rectangular and includes compartments on three sides in which said shelves are disposed.

6. A display system as claimed in claim 1, and further including additional full size items which are designed to coordinate with one or more of the plurality of full size items and which are displayed on said shelves.

7. A display system as claimed in claim 1, wherein a scale of said miniature size items to the full size items is smaller than about 1:4.

8. A display system as claimed in claim 1, wherein there are two miniature size articles on top of the shelving unit, each said miniature size article including a different plurality of miniature size items.

9. A display system for bed accessories comprising:
a shelving unit having a top and one or more shelves beneath said top on which items can be displayed for sale;
a miniature size bed displayed on said top, the miniature size bed including a plurality of miniature size bed accessories associated with said miniature size bed; and
a plurality of full size bed accessories, corresponding to said miniature size accessories, which are displayed on said shelves.

10. A display system as claimed in claim 9, and further including a transparent cover disposed over said miniature size bed.

11. A display system as claimed in claim 10, wherein said shelving unit is rectangular and includes compartments on three sides in which said shelves are disposed.

12. A display system as claimed in claim 11, and further including additional full size items which are designed to coordinate with one or more of the plurality of full size items and which are displayed on said shelves.

13. A display system as claimed in claim 12, wherein a scale of said miniature size bed accessories to the full size items is smaller than about 1:4.

14. A display system as claimed in claim 9, wherein there are two miniature size beds on top of the shelving unit, each said miniature size bed including a different plurality of miniature size bed accessories.

15. A method of displaying items for sale comprising the steps of:
providing a shelving unit having a top and one or more shelves beneath the top on which items can be displayed for sale;
displaying a miniature size article on the top, the miniature size article including a plurality of miniature size items associated with the miniature size article; and
displaying a plurality of full size items, corresponding to the miniature size items, on the shelves.

16. A method of displaying as claimed in claim 15, and further including the step of disposing a transparent cover over the miniature size article.

17. A method of displaying as claimed in claim 15, wherein the miniature size scale article is an article of furniture.

18. A method of displaying as claimed in claim 17, wherein the miniature size article of furniture is a bed, and wherein the full scale items include bed accessories.

19. A method of displaying as claimed in claim 15, wherein the shelving unit is rectangular and includes compartments on three sides in which the shelves are disposed.

20. A method of displaying as claimed in claim 15, wherein a scale of the miniature size items to the full size items is smaller than about 1:4.

21. A method of displaying as claimed in claim 15, wherein said displaying step display two miniature size articles on top of the shelving unit, each miniature size article including a different plurality of miniature size items.
